(19) United States
(12) Patent Application Publication
(10) Pub. No.: US 2012/0031726 A1
(43) Pub. Date: Feb. 9, 2012

(54) MODULAR CLUTCH ASSEMBLY

(75) Inventors: Bradly C. Grubb, Bristol, TN (US); Jared B. Godbey, Abingdon, VA (US); Julian Raphael, Abingdon, VA (US)

(73) Assignee: COLUMBUS MCKINNON CORPORATION, Amherst, NY (US)

(21) Appl. No.: 12/851,309

(22) Filed: Aug. 5, 2010

(51) Int. Cl. F16D 13/40

(52) U.S. Cl. 192/66.31

(57) ABSTRACT

A modular clutch assembly (15) comprising a first rotary member (16) having a first torque transfer surface (73 or 69), said first rotary member configured to rotate about an axis (x-x) and to rotationally couple to a first shaft (20), a second rotary member (22) configured to rotate about the axis and to rotationally couple to a second shaft (21), a pressure plate (23) configured to rotate about the axis, at least one of the second member and the pressure plate having a second torque transfer surface (78 or 66) opposing the first torque transfer surface, a spring element (29) configured to bias the opposed first and second torque transfer surfaces towards each other, and a pilot bearing (30) configured to act between the second member and the first shaft or the first member and the second shaft.

### TECHNICAL FIELD

The present invention relates generally to the field of clutches and, more particularly, to an improved modular clutch for preventing the transmission of excessive torque in, for example, hoist systems.

### BACKGROUND ART

Clutches are well known in the art and are generally used to transmit force between two rotating shafts. One of the shafts is typically attached to a motor, sometimes referred to as the driving member, and the other shaft provides output power for work to be done, often referred to as the driven member. The clutch connects the two shafts so that they can be either engaged so that they spin at the same speed, or decoupled and disengaged so they spin at different speeds.

U.S. Pat. No. 1,807,210 is directed to a friction coupling and generally discloses a key gear having a hub, follower ring, spring and cylindrical shell.

U.S. Pat. No. 2,953,911 is directed to a drive coupling and discloses a driven plate with radial grooves, hub, driving plate, pressure plate and clutch springs.

U.S. Pat. No. 7,591,357 is directed to a crank shaft torque modulator and discloses a driven hub, clutch spring, carrier disk, thrust washer, crank shaft pulley and mounting hub.

### BRIEF SUMMARY OF THE INVENTION

With parenthetical reference to the corresponding parts, portions or surfaces of the disclosed embodiments, merely for purposes of illustration and not by way of limitation, the present invention provides a modular clutch assembly (15) comprising a first rotary member (16) having a first torque transfer surface (73 or 69), said first rotary member configured to rotate about an axis (x-x) and to rotationally couple to a first shaft (20), a second rotary member (22) configured to rotate about the axis and to rotationally couple to a second shaft (21), a pressure plate (23) configured to rotate about the axis, at least one of the second member and the pressure plate having a second torque transfer surface (78 or 66) opposing the first torque transfer surface, a spring element (29) configured to bias the opposed first and second torque transfer surfaces towards each other, and a pilot bearing (30, 105 or 106) positioned to act radially between the second member and the first shaft or the first member and the second shaft.

The first rotary member may be a driving member and the second rotary member may be a driven member. The second member may have the second torque transfer surface (78) and the first member may comprise a third torque transfer surface (69) and the pressure plate may comprise a fourth torque transfer surface (66) opposing the third torque transfer surface. The pressure plate may be rotationally fixed (26, 31) relative to the second member.

The assembly may further comprise an adjusting nut (32) configured to rotate about the axis and to couple to the second member, the first member, pressure plate, and spring element disposed between the second member and the adjusting nut, the adjusting nut having an inner surface (53) and the pressure plate having a surface (62) opposing the inner surface of the adjusting nut, and wherein the spring element acts between the inner surface of the adjusting nut and the surface of the pressure plate opposing the inner surface of the adjusting nut. The adjusting nut and the second member may be configured such that rotational movement of the adjusting nut relative to the second member adjusts the bias of the spring element. The assembly may further comprise a lock (35) configured to selectively inhibit rotation of the second member relative to the adjusting nut.

The assembly may further comprise a second bearing (36) positioned to act radially between the second member and an external surface (38). The second member may comprise an outer journal (39) for receiving the second bearing. The pilot bearing (30) may be positioned directly between the second member and the first shaft. The pilot bearing (105) may be positioned directly between the first member and the second shaft. The pilot bearing (106) may be positioned directly between the second member and the first member.

The second torque transfer surface may comprise a slot relief (40). The second torque transfer surface and the fourth torque transfer surface may each comprise a slot relief (40, 25). The first torque transfer surface may comprise a friction layer (100) and the third torque transfer surface may comprise a friction layer (101). The friction layer may be contoured or tapered.

The spring element may comprise a first spring constant for a first range of deflection (103) and a second spring constant for a second range of deflection (104), wherein the second spring constant is less than about 25% of the first spring constant. The spring element may comprise a spring orientated about the axis and the pressure plate may comprise a pilot ring (41) configured to retain the spring in a position centered about the axis.

In another aspect the invention provides a modular clutch assembly comprising a first rotary member having a first torque transfer surface, the first rotary member configured to rotate about an axis and to rotationally couple to a first shaft, a second rotary member configured to rotate about the axis and to rotationally couple to a second shaft, a pressure plate configured to rotate about the axis, at least one of the second member and the pressure plate having a second torque transfer surface opposing the first torque transfer surface, a spring element configured to bias the opposed first and second torque transfer surfaces towards each other, an adjusting nut configured to rotate about the axis and couple to the second member, the first member, pressure plate, and spring element disposed between the second member and the adjusting nut, the adjusting nut having an inner surface and the pressure plate having a surface opposing the inner surface of the adjusting nut, wherein the spring element acts between the inner surface of the adjusting nut and the surface of the pressure plate opposing the inner surface of the adjusting nut; and wherein the adjusting nut and the second member are configured such that rotational movement of the adjusting nut relative to the second member adjusts the bias of the spring element.

An object of the invention is to provide an improved clutch. This and other objects and advantages will become apparent from the forgoing and ongoing written specification, the drawings and the claims.

### BRIEF DESCRIPTION OF THE DRAWINGS

FIG. 1 is a side view of an embodiment of the improved clutch.

FIG. 2 is a vertical cross-sectional view of the clutch shown in FIG. 1, taken generally on line A-A of FIG. 1.

FIG. 3 is a top exploded view of the clutch shown in FIG. 1.

FIG. 4 is a bottom exploded view of the clutch shown in FIG. 3.

FIG. 5 is a graph of the spring force for the clutch shown in FIG. 1.

FIG. 6 is a side view of the clutch shown in FIG. 1 acting between two shafts.

FIG. 7 is a vertical cross-sectional view of the clutch and shafts shown in FIG. 6, taken generally on line B-B of FIG. 6.

FIG. 8 is a vertical cross-sectional view of an alternative embodiment of the clutch shown in FIG. 2.

FIG. 9 is a vertical cross-sectional view of a second alternative embodiment of the clutch shown in FIG. 2.

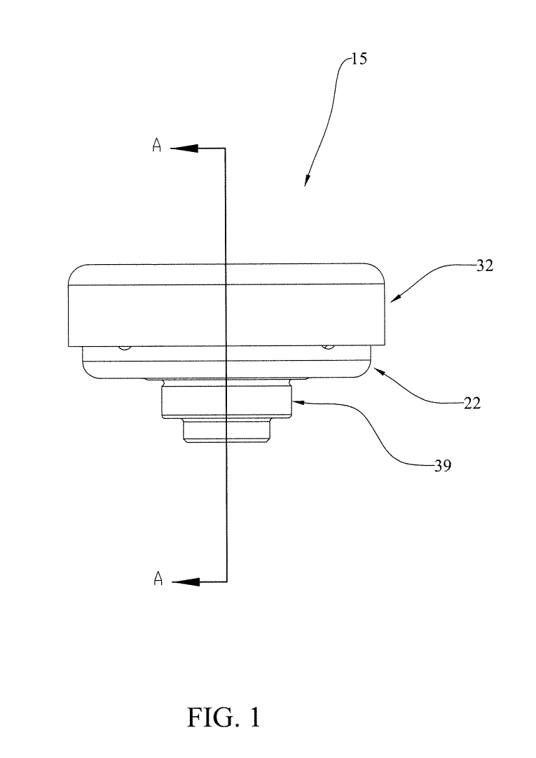

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

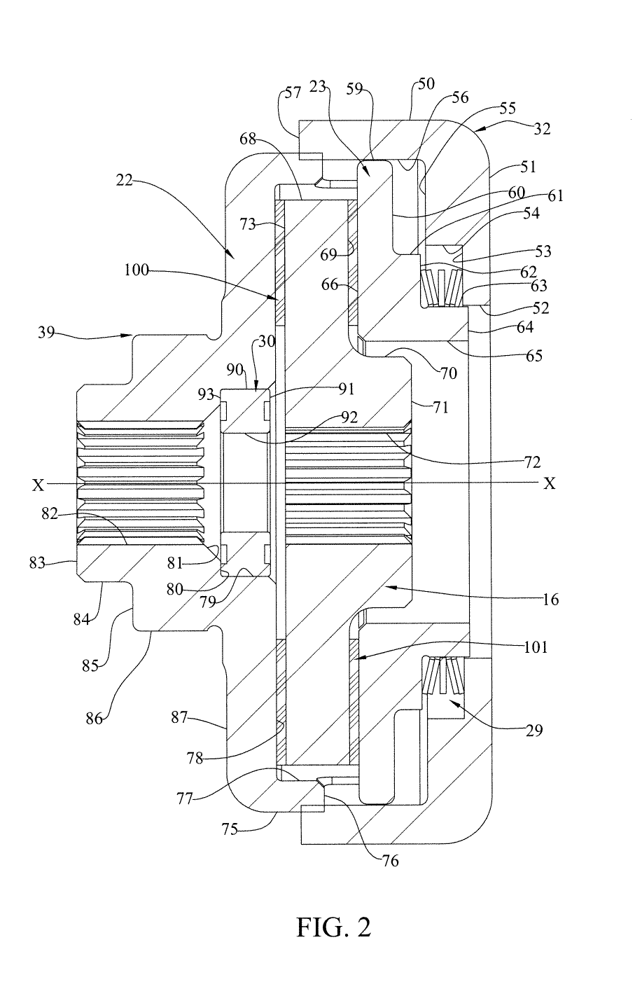

Referring now to the drawings and, more particularly, to FIGS. 2-4 thereof, this invention provides an improved clutch assembly, an embodiment of which is generally indicated at 15. Assembly 15 generally includes adjusting nut 32, spring 29, pressure plate 23, friction disk 16, driven hub 22, and pilot bearing 30. An external bearing 36 may also be employed. As shown, clutch 15 is generally a cylindrical structure elongated along and orientated about axis x-x.

As shown in FIG. 2, adjusting nut 32 is generally an annular structure orientated about axis x-x and bounded by outwardly-facing horizontal cylindrical surface 50, rightwardly-facing vertical annular surface 51, inwardly-facing horizontal cylindrical surface 52, leftwardly-facing vertical annular surface 53, inwardly facing horizontal cylindrical surface 54, leftwardly-facing vertical annular surface 55, inwardly-facing horizontal cylindrical surface 56, and leftwardly-facing vertical annular surface 57, joined at its outer marginal end to the left marginal end of cylindrical surface 50.

As shown in FIG. 2, pressure plate 23 is generally a ring-shaped annular structure orientated about axis x-x and bounded by outwardly-facing horizontal cylindrical surface 59, rightwardly-facing vertical annular surface 60, outwardly-facing horizontal cylindrical surface 61, rightwardly-facing vertical annular surface 62, outwardly-facing horizontal cylindrical surface 63, rightwardly-facing vertical annular surface 64, inwardly-facing horizontal cylindrical surface 65, and leftwardly-facing vertical annular surface 66, joined at its outer marginal end to the left marginal end of surface 59.

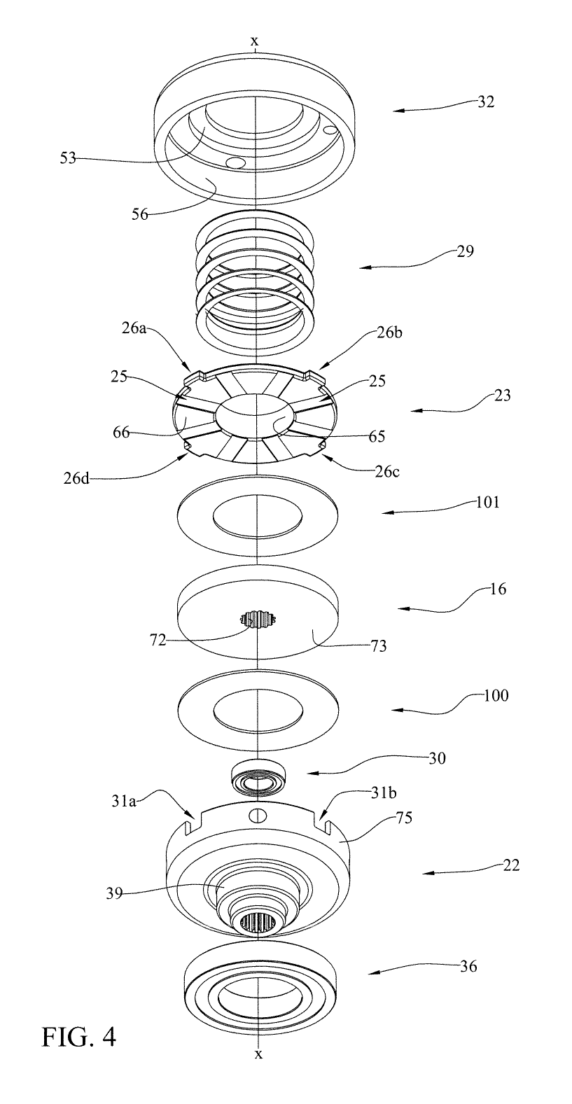

As shown in FIG. 4, four protrusions or tabs 26a-26d extend radially out from cylindrical surface 59. Tabs 26a-26d are dimensioned to fit into corresponding slots 31a-31d, which are described below. When tabs 26a-26d are positioned in slots 31a-31d, respectively, pressure plate 23 is held such that it rotates with rotation of driven hub 22. In addition, a number of radially extending reliefs 25 are cut into surface 66 of pressure plate 23. These reliefs extend from surface 65 to surface 59 and are configured for dust collection and increased clutch pressure.

Friction or driving hub 16 is generally a ring-shaped cylindrical structure orientated about axis x-x and bounded by outwardly-facing horizontal cylindrical surface 68, rightwardly-facing vertical annular surface 69, outwardly-facing horizontal cylindrical surface 70, rightwardly-facing vertical annular surface 71, inwardly-facing horizontal cylindrical surface 72, and leftwardly-facing vertical annular surface 73, joined at its outer marginal end to the left marginal end of surface 68.

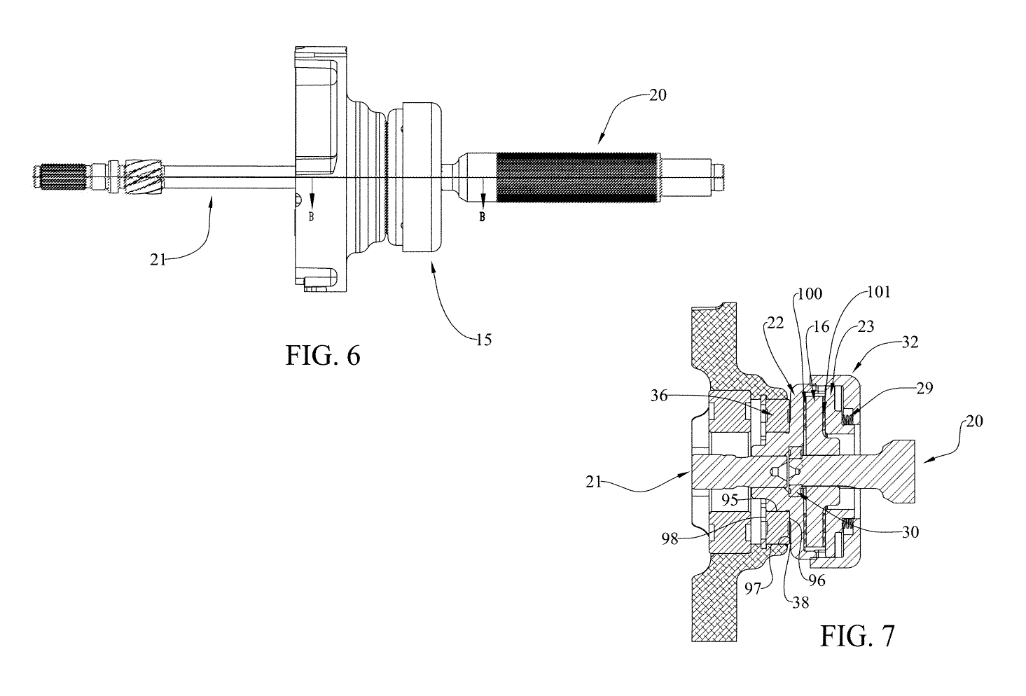

As shown in FIGS. 2, 6 and 7, cylindrical surface 72 of driving hub 16 is splined and forms a bore configured to receive the correspondingly splined end of first shaft 20 for rotational engagement. Thus, when shaft 20 engages the splined bore formed by surface 72, rotation of driving shaft 20 about axis x-x causes corresponding rotation of hub 16 about axis x-x.

As shown in FIG. 2, driven hub 22 is generally a cylindrical annular structure orientated about axis x-x and bounded by outwardly-facing horizontal cylindrical surface 75, rightwardly-facing vertical annular surface 76, inwardly-facing horizontal cylindrical surface 77, rightwardly-facing vertical annular surface 78, inwardly-facing horizontal cylindrical surface 79, rightwardly-facing vertical annular surface 80, rightwardly and inwardly-facing frustoconical surface 81, inwardly-facing horizontal cylindrical surface 82, leftwardly-facing vertical annular surface 83, outwardly-facing horizontal cylindrical surface 84, leftwardly-facing vertical annular surface 85, outwardly-facing horizontal cylindrical surface 86, and leftwardly-facing vertical annular surface 87, joined at its outer marginal end to the left marginal end of surface 75.

As shown in FIGS. 2, 6 and 7, cylindrical surface 82 of driven hub 22 is splined and forms a bore configured to receive the correspondingly splined end of second shaft 21 for rotational engagement. Thus, when shaft 21 engages the splined bore formed by surface 32, rotation of driven hub 22 about axis x-x causes corresponding rotation of second shaft 22 about axis x-x.

As shown in FIGS. 2-4 and 7, in this embodiment driving hub 16 includes conventional annular non-metallic composite friction liners 100 and 101 bonded to the outer portion of surface 73 and surface 69 of hub 16, respectively. Friction liner 100 provides a desired contact area between surface 73 of driving hub 16 and surface 78 of driven hub 22. Friction liner 101 in turn provides a desired contact area between surface 69 of hub 16 and surface 66 of pressure plate 23. While in this embodiment liners 100 and 101 are bonded to hub 16, alternatively they could be free floating. Also, liners 100 and 101 may be contoured to control the size, shape and location of the contact area and resulting torque between driving hub 16 and driven hub 22. For example, liners 100 and 101 may have tapered or beveled outside and inside diameters on their leftwardly-facing and rightwardly-facing outer surfaces, respectively.

As shown in FIGS. 2 and 7, surfaces 79 and 80 form an annular ledge on which pilot bearing 30 is positioned. As shown in FIG. 2, pilot bearing 30 is generally a ring-shaped cylindrical structure orientated about axis x-x and bounded by outwardly-facing horizontal cylindrical surface 90, rightwardly-facing vertical annular surface 91, inwardly-facing horizontal cylindrical surface 92, and leftwardly-facing vertical annular surface 93, joined at its outer marginal end to the left marginal end of cylindrical surface 90. As shown, the diameter of outer cylindrical surface 90 is slightly less than the diameter of surface 79 such that pilot bearing 30 fits within and abuts cylindrical surface 79 of driven hub 22.

As shown in FIG. 7, inner cylindrical surface 92 of bearing 30 is configured to receive the left marginal end of shaft 20 and to act as a bearing surface with respect to that left marginal end portion of rotating shaft 20 that protrudes beyond the left side of the bore defined by surface 72 of friction hub 16. Pilot bearing 30 allows for rotation of shaft 20 about axis x-x while holding the end of shaft 20, and therefore friction hub 16, in proper alignment.

Surfaces 86 and an inner portion of surface 87 of hub 22 form outer journal 39 for receiving outer bearing 36. As shown in FIG. 7, bearing 36 is generally a ring-shaped cylindrical annular structure orientated about axis x-x and bounded by outwardly-facing horizontal cylindrical surface 95, rightwardly-facing vertical annular surface 96, inwardly-facing horizontal cylindrical surface 97, and leftwardly-facing vertical annular surface 98, joined at its outer marginal end to the left marginal end of outwardly-facing horizontal cylindrical surface 95. Inwardly-facing horizontal cylindrical surface 97 of bearing 36 is configured to bear against the outer cylindrical surface 86 of driven hub 22, and the outer cylindrical surface 95 of bearing 36 is configured to bear against an external surface 38. Thus, bearing 36 allows for rotation of driven hub 22 about axis x-x relative to external surface 38 while holding driven hub 22 in proper alignment.

As shown in FIGS. 2-4, spring 29 bears on one side against surface 53 of adjusting nut 32 and on the other side against opposing surface 62 of pressure plate 23. In operation, spring 29 presses against surface 53 of adjusting nut 32 and surface 62 of pressure plate 23, causing friction hub 16 to be compressively clamped between pressure plate 23 and driven hub 22. This encourages driven hub 22 to rotate together with friction hub 16 through contact friction at friction liners 100 and 101. When the driving torque exceeds the friction torque, driven hub 22 will slip relative to friction hub 16, resulting in shaft 21 no longer rotating at the same speed as shaft 20.

Inner cylindrical surface 56 of adjustment nut 32 is threaded and outer cylindrical surface 75 of driven hub 22 is corresponding threaded such that adjusting nut 32 can be rotationally connected to driven hub 22. As shown, spring 29, pressure plate 23, friction hub 16, and pilot bearing 30 are orientated between adjustment nub 32 and driven hub 22 and, in this embodiment, housed within and between adjustment nut 32 and driven hub 22. Accordingly, rotation of adjustment nut 32 in one direction relative to driven hub 22 causes nut 32 and hub 22 to move closer together, thereby decreasing the distance between surface 53 of nut 32 and surface 62 of plate 23 and increasing the countering bias of spring 29. Rotation of adjustment nut 32 in the other direction relative to driven hub 22 increases the gap between such surfaces and decreases the bias of spring 29. The ability in this way to adjust the gap between surfaces 62 and 53 allows for the spring bias to be adjusted as desired. Thus, if over time either spring 29 losses its elasticity or if any of liner 100, liner 101, surfaces 69 and/or 73 of driving hub 16, surface 66 of pressure plate 23 and/or surface 78 of driven hub 22 are worn away, adjustment nut 32 may be screwed down relative to driven hub 22 to maintain the desired bias of spring 29.

Cylindrical surface 63 of pressure plate 23 acts as a guide and serves to maintain the orientation of spring 29 about axis x-x. The inner surface of the bottom sections of spring 29 are dimensioned to fit around surface 63 of pressure plate 23 such that spring 29 is retained in proper alignment.

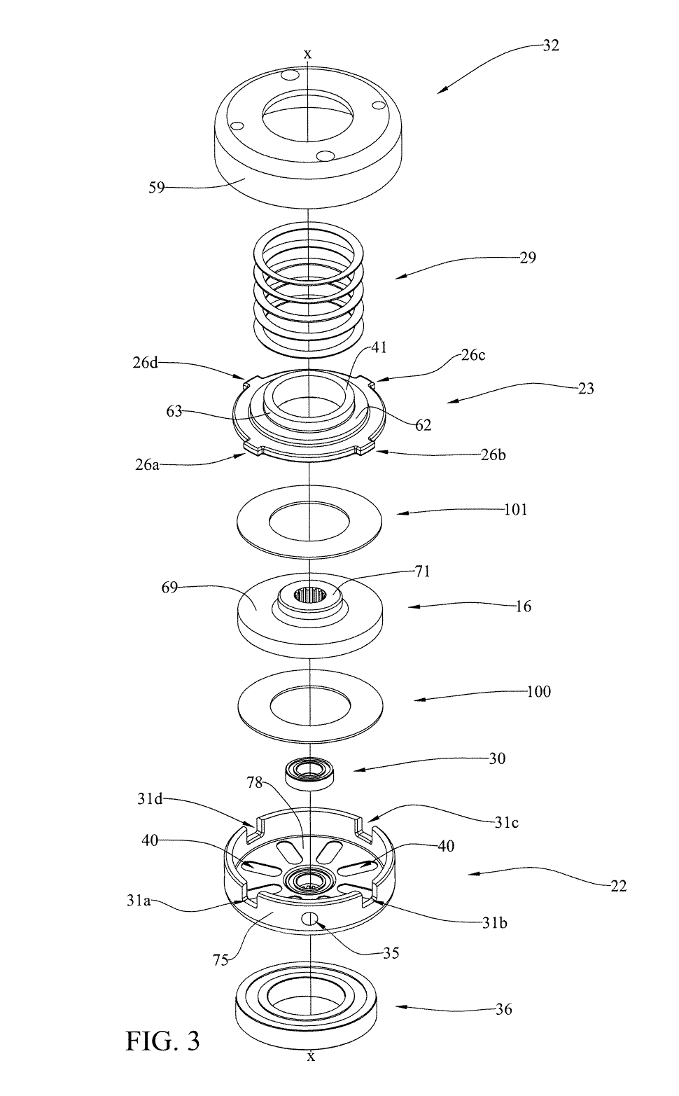

As shown in FIGS. 3-4, notches 31a-31d are cut between surfaces 75 and 77 and into surface 76 of hub 22 at radial positions that correspond to the radial positions of tabs 26a-26d, respectively, to provide locking engagement. Thus, the four rectangular-shaped tabs or notch keys 26a-26d are located on the outer edge of pressure plate 23 and fit into the corresponding notches 31a-31d, respectively, in driven hub 22 to prevent pressure plate 23 from rotating relative to driven hub 22 when assembled.

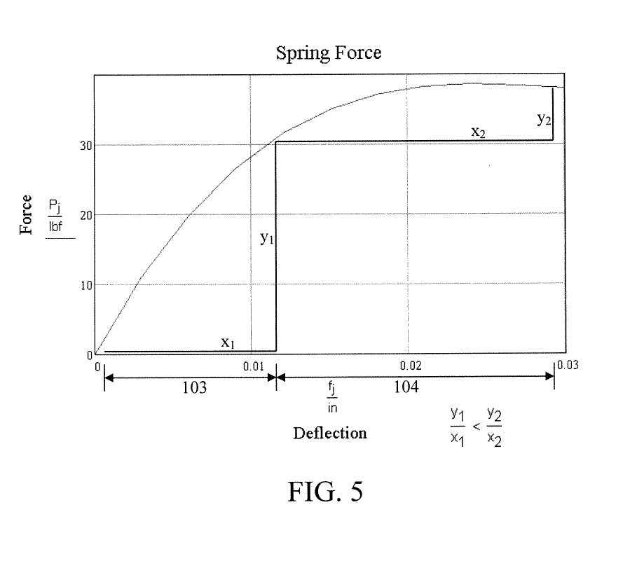

As shown, clutch spring 29 is arranged concentric to shafts 20 and 21. In this embodiment, spring 29 is a Belleville spring, which allows for varying numbers of springs and spacers in varying arrangements to be employed as desired. Alternatively, a coil spring or other state of the art bias device or spring set may be employed. In this embodiment, spring 29 has a non-standard spring force displacement curve. As shown in FIG. 5, the force displacement curve for spring 29 includes region 102 of operation in which the bias force is relatively constant. As shown, spring 29 has a first spring constant in first range of deflection 103 and a different spring constant for second range of deflection 104. In this embodiment, the spring constant for range 104 is less than about 25% of the spring constant for range 103. The advantage of this arrangement is that the relatively flat or minimally sloped region 104 of the force-displacement curve allows a relatively constant force to be applied to the clutch even if the spring displacement changes due to clutch wear.

As shown in FIGS. 3-4, outer surface 75 of driven hub 22 includes lock 35. In this embodiment, lock 35 is a nylon plug that frictionally engages the inner threaded surface 56 of adjustment nut 32, thereby restricting rotation of adjustment nut 32 relative to driven hub 22. This allows for adjustment nut 32 to be screwed onto driven hub 22 to provide the desired gap between surfaces 62 and 53 and to prevent relative rotation thereafter. Alternative locking mechanisms may be employed, such as a locking screw or other state of the art thread locking device or method.

As described, clutch 15 is a modular member in that may be easily placed into existing drive shaft assemblies, including without limitation hoist assemblies. All of the components of the clutch, other than bearing 36, are housed between adjustment nut 32 and driven hub 22. In addition, added strength is derived from having pilot bearing 30 and second bearing 36 acting on the same intermediate structure of driven hub 22. Thus, clutch 15 may be quickly removed, installed or adjusted and reset. Clutch 15 also requires only one direct support bearing 36. Drive shaft 20 is supported by pilot bearing 30, which is internal or inside clutch 15. In addition, the spline fit between drive shaft 20 and friction hub 16 controls unwanted radial movements and eliminates the need for a second direct support bearing. Spring 29 is designed to allow quick change of capacity. For example, four springs for a ½ horsepower rated clutch and two springs for a ¼ horsepower rated clutch may be used. In this embodiment, the use of Bellville springs designed with a relatively flat force curve helps tolerate clutch wear with minimal reduction in clutch torque.

Clutch 15 is also configured for easy assembly. Adjustment nut 32 is tightened relative to driven hub 22 until spring 29 is flat, after which adjustment nut 32 is backed-off a minimal amount, preferably ⅛ to ¼ of a turn. The clutch is then set. As the clutch wears, the compressed height of the springs may increase and eventually the clutch torque would be reduced. With clutch 15, the clutch can be reset by tightening adjustment nut 32 relative to driven hub 22 to flatten spring 29 and then by backing adjustment nut 32 off a minimal amount again.

While a single pressure plate 23 and friction hub 16 are shown and described, multiple pressure plates and friction hubs may be used to increase torque transfer as desired.

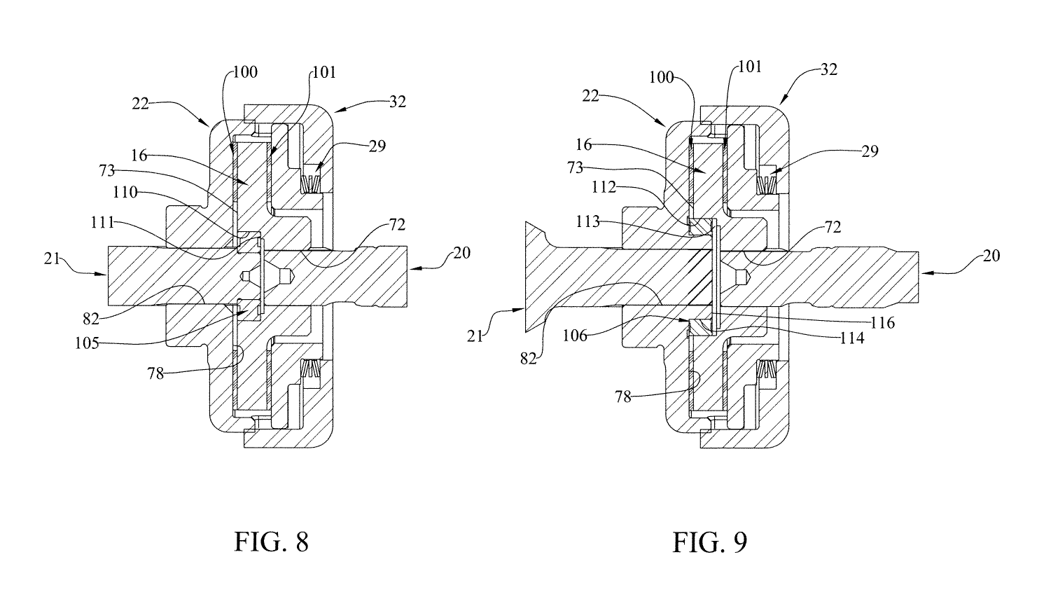

While in a first embodiment shown in FIGS. 2-4 and 6-7 the radial pilot bearing 30 is shown as being held by driven hub 22 and acting directly between driven hub 22 and the protruding end of shaft 20, other pilot bearing configurations may be used, examples of which are shown in FIGS. 8 and 9. In the alternative configuration shown in FIG. 8, driven hub 22 does not include surfaces 79 and 80 and the annular ledge formed thereby, but instead surface 78 of hub 22 extends and is joined at its inner marginal end to the right marginal end of the extension of surface 82 of hub 22. And instead of surface 73 of friction hub 16 extending inwardly to surface 72 of hub 16, an annular ledge is formed in friction hub 16 by inwardly-facing horizontal cylindrical surface 110 and leftwardly-facing vertical annular surface 110 of friction hub 16. As shown in FIG. 8, surfaces 110 and 111 of friction hub 16 form an annular ledge on which pilot bearing 105 is positioned. Internal bearing 105 thereby acts directly between friction hub 16 and the protruding end of shaft 21, rather than between driven hub 22 and the protruding end of shaft 20 as in the first embodiment. This is essentially a reversed configuration to the configuration shown in FIGS. 2-4 and 6-7.

FIG. 9 shows yet another alternative pilot bearing configuration, in which internal radial bearing 106 acts directly between driven hub 22 and friction hub 16, and only indirectly between driven hub 22 and shaft 20. As shown in FIG. 9, instead of extending to surfaces 79 and then 80, surface 78 of driven hub 22 extends to outwardly-facing horizontal cylindrical surface 114 of hub 22, which in turn is joined to the extension of surface 82 of hub 22 by rightwardly-facing vertical annular surface 116 of hub 22. And instead of surface 73 of friction hub 16 extending inwardly to surface 72 of hub 16, an annular ledge is formed in friction hub 16 by inwardly-facing horizontal cylindrical surface 112 and leftwardly-facing vertical annular surface 113 of friction hub 16. As shown in FIG. 9, surfaces 112 and 113 of friction hub 16 form an annular ledge and the inner portion of surface 78 and surface 114 form an opposing annular ledge between which pilot bearing 106 is positioned. Internal bearing 106 thereby acts directly between friction hub 16 and driven hub 22, with shaft 20 constrained in turn by splined surface 72 of friction hub 16. Like the first two embodiments, pilot bearing 106 provides a radial constraint while allowing axial rotation.

The present invention contemplates that many changes and modifications may be made. Therefore, while the presently-preferred form of the modular clutch assembly has been shown and described, and several modifications and alternatives discussed, persons skilled in this art will readily appreciate that various additional changes and modifications may be made without departing from the spirit and scope of the invention, as defined and differentiated by the following claims.

What is claimed is:

1. A modular clutch assembly comprising:
a first rotary member having a first torque transfer surface;
said first rotary member configured to rotate about an axis and to rotationally couple to a first shaft;
a second rotary member configured to rotate about said axis and to rotationally couple to a second shaft;
a pressure plate configured to rotate about said axis;
at least one of said second member and said pressure plate having a second torque transfer surface opposing said first torque transfer surface;
a spring element configured to bias said opposed first and second torque transfer surfaces towards each other; and
a pilot bearing positioned to act radially between said second member and said first shaft or between said first member and said second shaft.

2. The assembly set forth in claim 1, wherein said first rotary member is a driving member and said second rotary member is a driven member.

3. The assembly set forth in claim 1, wherein said second member has said second torque transfer surface.

4. The assembly set forth in claim 3, wherein said first member comprises a third torque transfer surface and said pressure plate comprises a fourth torque transfer surface opposing said third torque transfer surface.

5. The assembly set forth in claim 4, wherein said pressure plate is rotationally fixed relative to said second member.

6. The assembly set forth in claim 5, and further comprising:
an adjusting nut configured to rotate about said axis and couple to said second member;
said first member, pressure plate, and spring element disposed between said second member and said adjusting nut;
said adjusting nut having an inner surface and said pressure plate having a surface opposing said inner surface of said adjusting nut;
and wherein said spring element acts between said inner surface of said adjusting nut and said surface of said pressure plate opposing said inner surface of said adjusting nut.

7. The assembly set forth in claim 6, wherein said adjusting nut and said second member are configured such that rotational movement of said adjusting nut relative to said second member adjusts said bias of said spring element.

8. The assembly set forth in claim 7, and further comprising a lock configured to selectively inhibit rotation of said second member relative to said adjusting nut.

9. The assembly set forth in claim 1, and further comprising a second bearing positioned to act radially between said second member and an external surface.

10. The assembly set forth in claim 9, wherein said second member comprises an outer journal for receiving said second bearing.

11. The assembly set forth in claim 1, wherein said second torque transfer surface comprises a slot relief.

12. The assembly set forth in claim 4, wherein said second torque transfer surface and said fourth torque transfer surfaces each comprise a slot relief.

13. The assembly set forth in claim 1, wherein said first torque transfer surface comprises a friction layer.

14. The assembly set forth in claim 4, wherein said first and third torque transfer surfaces each comprise a friction layer.

15. The assembly set forth in claim 13, wherein said friction layer is contoured.

16. The assembly set forth in claim 1, wherein said spring element comprises a first spring constant for a first range of deflection and a second spring constant for a second range of deflection and wherein said second spring constant is less than about 25% of said first spring constant.

17. The assembly set forth in claim 1, wherein said spring element comprises a spring oriented about said axis and said pressure plate comprises a pilot ring configured to retain said spring in a position centered about said axis.

18. The assembly set forth in claim 1, wherein said pilot bearing is positioned to act directly between said second member and said first shaft or directly between said first member and said second shaft.

19. The assembly set forth in claim 1, wherein said pilot bearing is positioned directly between said second member and first member.

20. A modular clutch assembly comprising:
a first rotary member having a first torque transfer surface;
said first rotary member configured to rotate about an axis and to rotationally couple to a first shaft;
a second rotary member configured to rotate about said axis and to rotationally couple to a second shaft;
a pressure plate configured to rotate about said axis;
at least one of said second member and said pressure plate having a second torque transfer surface opposing said first torque transfer surface;
a spring element configured to bias said opposed first and second torque transfer surfaces towards each other;
an adjusting nut configured to rotate about said axis and couple to said second member;
said first member, pressure plate, and spring element disposed between said second member and said adjusting nut;
said adjusting nut having an inner surface and said pressure plate having a surface opposing said inner surface of said adjusting nut;
wherein said spring element acts between said inner surface of said adjusting nut and said surface of said pressure plate opposing said inner surface of said adjusting nut; and
wherein said adjusting nut and said second member are configured such that rotational movement of said adjusting nut relative to said second member adjusts said bias of said spring element.

21. The assembly set forth in claim 20, and further comprising a lock configured to selectively inhibit rotation of said second member relative to said adjusting nut.

22. The assembly set forth in claim 20, wherein said first rotary member is a driving member and said second rotary member is a driven member.

23. The assembly set forth in claim 20, wherein said second member has said second torque transfer surface, said first member comprises a third torque transfer surface and said pressure plate comprises a fourth torque transfer surface opposing said third torque transfer surface.

24. The assembly set forth in claim 23, wherein said pressure plate is rotationally fixed relative to said second member.

25. The assembly set forth in claim 20, and further comprising a pilot bearing positioned to act radially between said second member and said first shaft or between said first member and said second shaft.

26. The assembly set forth in claim 20, and further comprising a second bearing positioned to act radially between said second member and an external surface.

27. The assembly set forth in claim 26, wherein said second member comprises an outer journal for receiving said second bearing.

28. The assembly set forth in claim 20, wherein said spring element comprises a first spring constant for a first range of deflection and a second spring constant for a second range of deflection and wherein said second spring constant is less than about 25% of said first spring constant.

29. The assembly set forth in claim 20, wherein said spring element comprises a spring oriented about said axis and said pressure plate comprises a pilot ring configured to retain said spring in a position centered about said axis.
